(19) United States
(12) Patent Application Publication
(10) Pub. No.: US 2022/0012379 A1
(43) Pub. Date: Jan. 13, 2022

(54) SYSTEMS AND METHODS FOR MODELLING INTERACTIONS OF PHYSICAL ASSETS WITHIN A WORKSPACE

(71) Applicant: DIGITALOGIA CANADA INC., Milton (CA)

(72) Inventor: Kamran Athar Baqai, Milton (CA)

(21) Appl. No.: 17/369,438

(22) Filed: Jul. 7, 2021

Related U.S. Application Data
(60) Provisional application No. 63/049,028, filed on Jul. 7, 2020.

(51) Int. Cl. G06F 30/12; G06K 9/00; G06T 19/00; G06F 3/0481

(52) U.S. Cl. CPC G06F 30/12; G06K 9/00671; G06F 2111/02; G06F 3/04815; G06T 19/006

(57) ABSTRACT

An example method for modelling interactions of physical assets within a workspace includes: obtaining a workspace definition and an asset definition; generating a model by: (i) defining a root node designating a navigational region based on the workspace definition, and (ii) defining at least one child node designating an asset representation based on the asset definition; in response to a connection request from a client device: defining an avatar for the client device; locating the avatar within the model in the navigational region; and presenting the model with the avatar to the client device; navigating the avatar within the navigational region to a target location; manipulating the asset representation in accordance with an interaction request; computing a physical response of the physical asset and the workspace as a result of the manipulation; and outputting the computed physical response.

### CROSS REFERENCE TO RELATED APPLICATIONS

This application claims priority to U.S. Provisional Application No. 63/049,028, filed Jul. 7, 2020, the entirety of which is incorporated herein by reference.

### FIELD

The specification relates generally to extended and mixed reality systems, and more particularly to a system and method for modelling interactions of physical assets within a workspace.

### BACKGROUND

Planning for industrial system workspaces may be complex and involve configurations of many different physical assets. The size of the physical assets and time and reconfiguration required to change the planned requirements imposes strict accuracy needs during the planning phases. Often, planning is performed based on two-dimensional plans and schematics, which can be cumbersome and time-consuming.

### SUMMARY

According to an aspect of the present specification, a method for modelling interactions of physical assets within a workspace includes: obtaining a workspace definition representing a workspace and an asset definition representing a physical asset located within the workspace; generating a model by: (i) defining a root node for the model, the root node designating a navigational region of the model based on the workspace definition, and (ii) defining at least one child node descending from the root node, the child node designating an asset representation based on the asset definition; in response to a connection request from a client device: defining an avatar for the client device as a further child node descending from the root node; locating the avatar within the model in the navigational region; and presenting the model with the avatar to the client device; in response to a navigation request from the client device, the navigation request specifying a target location, navigating the avatar within the navigational region to the target location; in response to an interaction request from the client device, the interaction request specifying an interaction of the asset representation relative to the workspace, manipulating the asset representation in accordance with the interaction request; in response to manipulating the asset representation, computing a physical response of the physical asset and the workspace as a result of the interaction; and outputting the computed physical response.

According to another aspect of the present specification, a server for modelling interactions of physical assets within a workspace includes: a memory; a processor interconnected with the memory, the processor configured to: obtain a workspace definition representing a workspace and an asset definition representing a physical asset located within the workspace; generate a model by: (i) defining a root node for the model, the root node designating a navigational region of the model based on the workspace definition, and (ii) defining at least one child node descending from the root node, the child node designating an asset representation based on the asset definition; in response to a connection request from a client device: define an avatar for the client device as a further child node descending from the root node; locate the avatar within the model in the navigational region; and present the model with the avatar to the client device; in response to a navigation request from the client device, the navigation request specifying a target location, navigate the avatar within the navigational region to the target location; in response to an interaction request from the client device, the interaction request specifying an interaction of the asset representation relative to the workspace, manipulate the asset representation in accordance with the interaction request; in response to manipulating the asset representation, compute a physical response of the physical asset and the workspace as a result of the interaction: and output the computed physical response.

### BRIEF DESCRIPTION OF DRAWINGS

Implementations are described with reference to the following figures, in which:

FIG. 1 depicts a block diagram of an example system for modelling interactions of physical assets within a workspace;

FIG. 2 depicts a block diagram of certain internal components of the server of FIG. 1;

FIG. 3 depicts a flowchart of an example method for modelling interactions of physical assets within a workspace;

FIG. 4 depicts a schematic diagram of a node structure used to model interactions of physical assets within a workspace in the system of FIG. 1;

FIG. 5 depicts a schematic diagram of an example view of the model in the system of FIG. 1;

FIG. 6 depicts a schematic diagram of another example view of the model in the system of FIG. 1; and

FIGS. 7A and 7B depict schematic diagrams of the implementation of annotations in the system of FIG. 1.

### DETAILED DESCRIPTION

As described herein, an example system provides an interactive, three-dimensional model for collaboration by multiple users. The system employs extended or mixed reality features, including an interactive virtual reality model. The model is structured with a hierarchical node structure to enable users to navigate within a navigational region and interact with asset representations, including moving them, modifying them. Further, the system models a physical response of the manipulations of asset representations and outputs the physical response for feedback. In particular, the system supports multi-user capabilities, including updating the model in real-time based on the interactions, movements and other actions of each user.

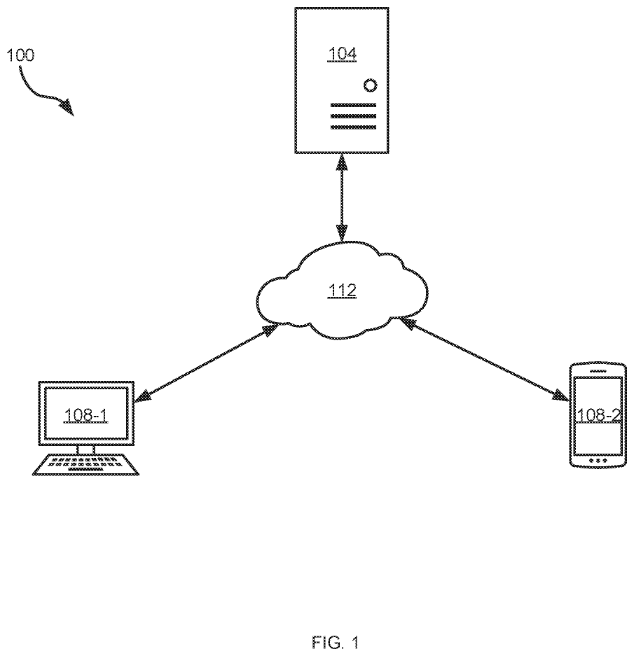

FIG. 1 depicts a block diagram of an example system 100 for modelling interactions of physical assets within a workspace. The system 100 includes a server 104 and client devices 108, of which two example client devices 108-1 and 108-2 are depicted, in communication via a network 112.

The server 104 may be any suitable server environment, including a series of cooperating servers, a cloud-based server, and the like. The server 104 is generally configured to model interactions of physical assets within a workspace. The internal components of the server 104 will be described in greater detail below.

The client devices 108-1, 108-2 (referred to herein generically as a client device 108 and collectively as client devices 108) may be computing devices such as laptop computers, desktop computers, tablets, mobile phones, kiosks, or the like. In some examples, the client devices 108 may be a wearable device, such as a head mounted device supporting virtual reality or augmented reality functionality. The client devices 108 may generally be used to display the models and interactions of the physical assets, and to allow users to interact with the interactive model. For example, the client devices 108 may implement a web browser application to access a site hosted at the server 104 enabling the functionality described herein.

The client devices 108 include suitable processors and memories storing machine-readable instructions which, when executed, cause the client devices 108 to perform the functionality described herein. The client devices 108 also include suitable communications interfaces (e.g., including transmitters, receivers, network interface devices, and the like) to communicate with other computing devices, such as the server 104, via the network 112.

The server 104 and the client devices 108 are in communication with one another via the network 112. The network 112 may include wired or wireless networks, including wide-area networks, such as the Internet, mobile networks, local area networks employing routers, switches wireless access points, combinations of the above, and the like.

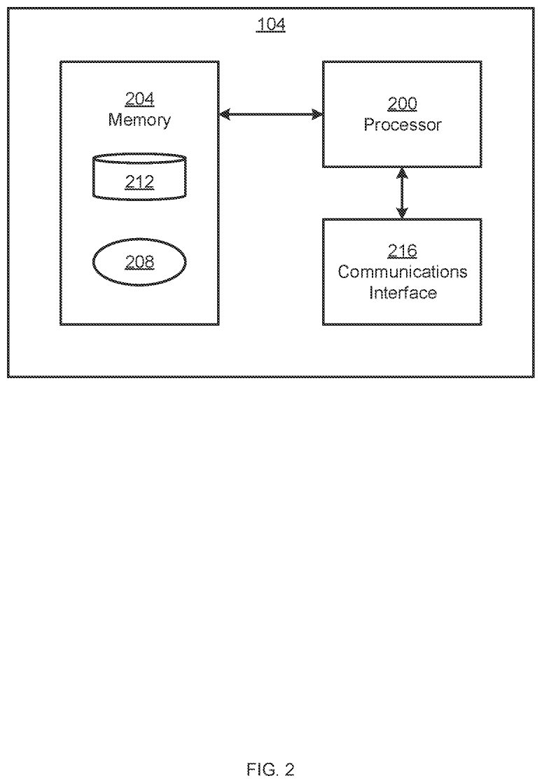

Turning now to FIG. 2, certain internal components of the server 104 are illustrated. The server 104 includes a processor 200 interconnected with a non-transitory machine-readable storage medium, such as a memory 204. The processor 200 may include a central processing unit (CPU), a microcontroller, a microprocessor, a processing core, or similar device capable of executing instructions. In other examples, the functionality implemented by the processor 200 may also be implemented by one or more specially designed hardware and firmware components or dedicated logic circuitry, such as a field-programmable gate array (FPGA), application-specific integrated circuits (ASIC), and the like.

The memory 204 may be an electronic, magnetic, optical, or other physical storage device that stores executable instructions. The memory 204 may include a combination of volatile memory (e.g., random access memory, or RAM), and non-volatile memory (e.g., read only memory or ROM, electrically erasable programmable read only memory or EEPROM, flash memory). The processor 200 and the memory 204 may each comprise one or more integrated circuits.

The memory 204 stores machine-readable instructions for execution by the processor 200. In particular, the memory 204 stores a modelling application 208 which, when executed by the processor 200, configures the server 104 to perform various functions discussed below in greater detail and related to the interaction modelling operation of the server 104. In some examples, the application 208 may also be implemented as a suite of distinct applications. The memory 204 also stores a repository 212 storing rules and data for the interaction modelling operation. For example, the repository 212 may store properties of various physical assets, a library of principles governing the responses of the physical assets, and the like.

The server 104 further includes a communications interface 216 enabling the server 104 to exchange data with other computing devices such as the computing devices 108 via the network 112. The communications interface 216 is interconnected with the processor 200 and includes suitable hardware (e.g., transmitters, receivers, network interface controllers and the like) allowing the server 104 to communicate with other computing devices. The specific components of the communications interface 216 are selected based on the type of network or other links that the server 104 communicates over.

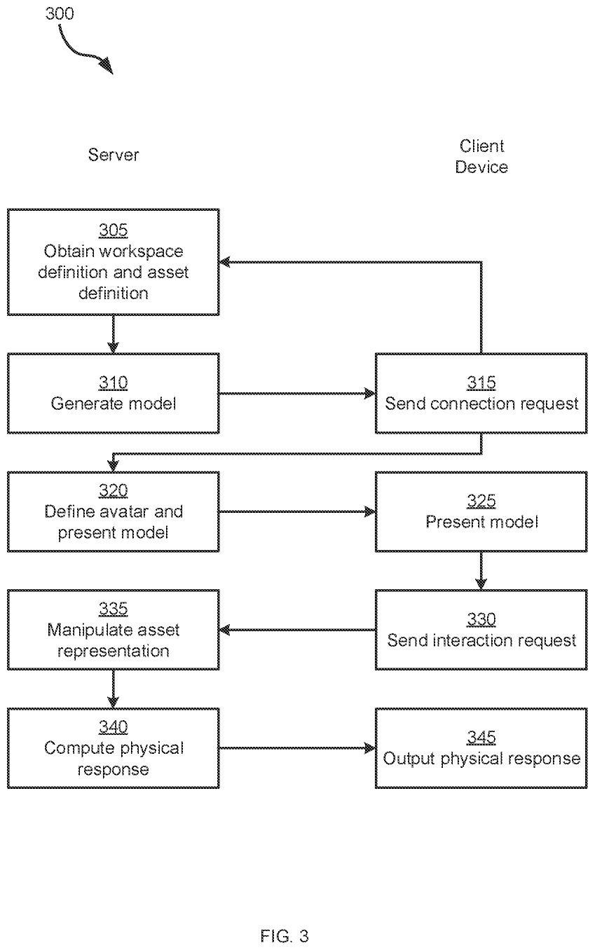

Turning now to FIG. 3, the functionality implemented by the server 104 will be discussed in greater detail. FIG. 3 illustrates a method 300 of modelling interactions of physical assets within a workspace. The method 300 will be discussed in conjunction with its performance in the system 100, and particularly by the server 104, via execution of the application 208. In particular, the method 300 will be described with reference to the components of FIGS. 1 and 2. In other examples, the method 300 may be performed by other suitable devices or systems.

The method 300 is initiated at block 305, for example, in response to a user request from a client device. For example, the user may be an architect or engineer during the planning phase of a construction project, wishing to review the plans of the project prior to approval and construction. Thus, at block 305, the server 104 obtains a workspace definition representing the workspace, and at least one asset definition representing a physical asset within the workspace. For example, the workspace may be an industrial, commercial or residential setting under construction, and the physical asset may be a component to be constructed, including but not limited to, water, electrical and airflow conduits, beams and supports, heating, power, and cooling units, and the like. In other examples, the physical asset may be a component to be examined without a context of a workspace in which it is to be implemented. In such examples, the workspace may be defined according to a predefined workspace containing sufficient space for the physical asset to be located (i.e., an empty room or space).

The workspace definition may be a computer-implemented model or other suitable representation of the workspace. For example, the workspace definition may be a proprietary computer-aided design (CAD) model of the workspace. In other examples, the workspace definition may be a generated model built based on data captured by another computing device and representing the workspace. For example, a depth device may employ LIDAR, stereoscopy, or other depth measurement techniques to scan the workspace and create a digital representation of the workspaces based on the distances of the nearest surfaces from the depth device. In other examples, an imaging device, such as the camera of a smart phone, or the like, may capture images of the workspace and stitch them together using photogrammetry or other suitable techniques.

The asset definition may similarly be a computer-implemented model or other suitable representation of the physical asset. For example, the asset definition may be a proprietary CAD model of the physical asset. In other examples, the asset definition may be built based on data captured by another computing device and representing the physical asset, using similar image and/or depth capture and analysis techniques. In particular, the workspace definition and the asset definition may be different types of representations of the workspace and the physical asset, respectively.

In some examples, the server 104 may actively obtain the workspace definition and the asset definition from one of the client devices 108 or another computing device. For example, for a new workspace and physical asset, the server 104 may receive the workspace definition and the asset definition. In other examples, the server 104 may retrieve the workspace definition and the asset definition as previously defined from the memory 204.

At block 310, the server 104 generates a model supporting navigation and interaction from the client devices 108. In particular, the server 104 may generate a model with a hierarchical node structure, including a parent or root node defining a navigational region of the workspace, as well as one or more child nodes descending from the root node and defining objects or sub-regions within the workspace.

Thus, the server 104 defines a root node for the model, which designates a navigational region of the model based on the workspace definition. That is, the navigational region represents the physical space of the workspace. The navigational region may further have a three-dimensional coordinate system to locate child nodes within the parent nodes—i.e., to locate the representations of physical assets or other objects within the navigational region of the workspace. The volume of the navigational region may further impose outer bounds within which the child nodes may be defined.

The server 104 additionally defines at least one child node for the model. The child node descends from the root node and represents objects located in the navigational region. For example, the child node may represent the physical asset located within the workspace. Thus, the child node may designate an asset representation based on the asset definition. That is, the server 104 may import the asset definition as a child object of the workspace definition. In particular, the asset representation may be located in the navigational region by assigning the asset representation to a location in the coordinate system.

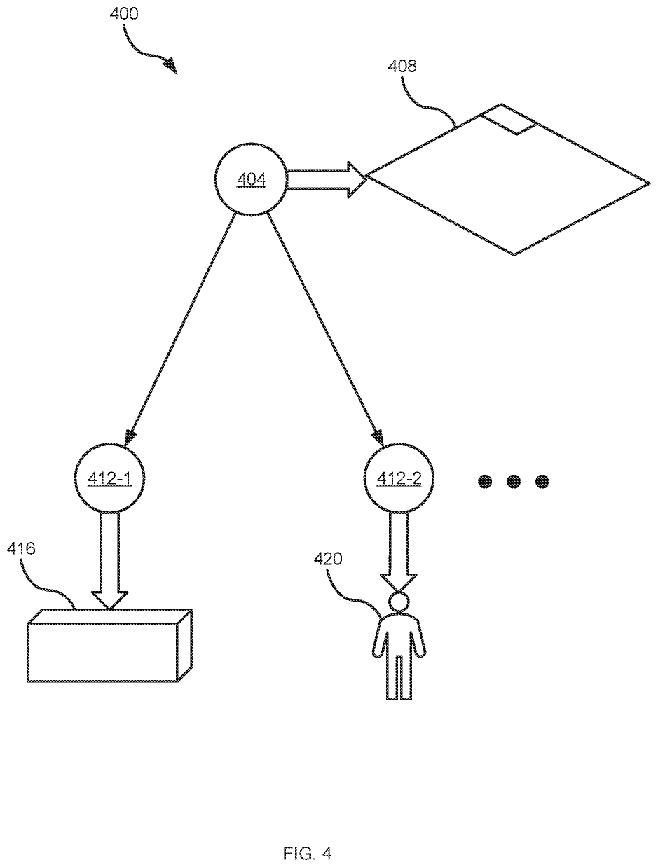

For example, referring to FIG. 4, a schematic diagram of an example node structure 400 is depicted. The node structure 400 includes a root node 404 designating a navigational region 408. In the present example, the navigational region 408 represents a collection of rooms, including a utility closet. The node structure 400 further includes a first child node 412-1 designating an asset representation 416. The asset representation 416-1 represents a physical asset, in the present example, a utility unit (e.g., an HVAC unit or the like). In particular, the relationship of the child node 412-1 and the root node 404 specifies that the asset representation 416 designated by the child node 412-1 is located in the navigational region 408 designated by the root node 404. The node structure 400 further includes a second child node 412-2, as will be described further below.

Returning to FIG. 3, at block 315, the client device 108-1 sends a connection request to the server. For example, the client device 108-1 may implement a web browser application to access a web site hosted at the server 104. The connection request may specify a workspace to model. For example, a user of the client device 108-1 may input a selection of a workspace.

In some examples, sending the connection request may additionally include authenticating the client device 108-1 with the server 104. For example, a user of the client device 108-1 may input a username and password to the client device 108-1. The client device 108-1 may then send the username and password to the server 104 for authentication.

At block 320, in response to the connection request from the client device 108-1, the server 104 defines an avatar for the client device 108-1 as a further child node descending from the root node. That is, the avatar is a figure representing the client device 108-1 (or a user of the client device 108-1) within the model. Since the avatar is designated as a child node of the root node, the server 104 locates the avatar within the navigational region designated by the root node. The avatar may be located, for example at a predefined start location (e.g., an origin of the coordinate system of the navigational region or the like).

For example, referring again to FIG. 4, the node structure 400 further includes the second child node 412-2 designating an avatar 420. The avatar 420 represents the client device 108-1 or a user of the client device 108-1 within the model. In particular, the relationship of the child node 412-2 and the root node 404 specifies that the avatar 420 designated by the child node 412-2 is located in the navigational region 408 designated by the root node 404.

After locating the avatar within the model, and more particularly within the navigational region of the model, the server 104 presents the model including the avatar, to the client device 108-1. For example, the server 104 may send the model to be rendered at the web browser application of the client device 108-1.

Returning again to FIG. 3, after sending the model to the client device 108-1, at block 325, the client device 108-1 may render the model and present it at a display of the client device 108-1.

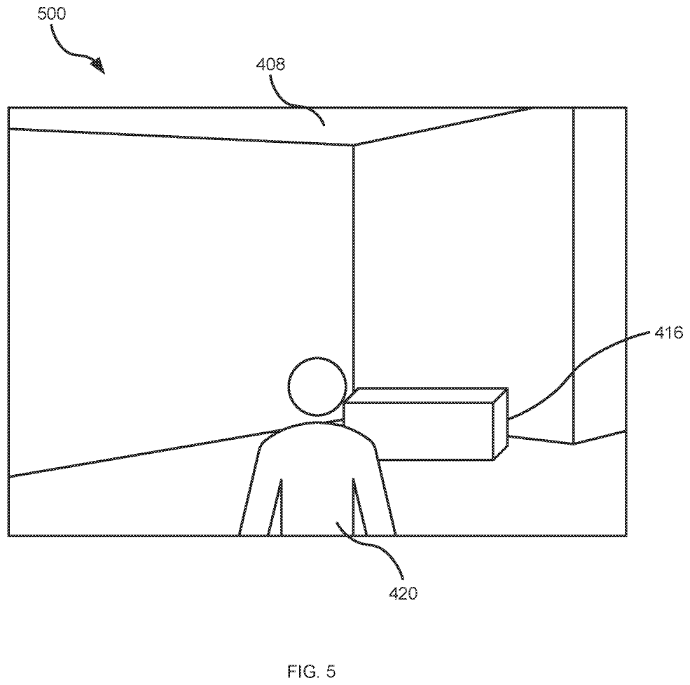

For example, referring to FIG. 5, a schematic diagram of a rendered view 500 of the model defined by the node structure 400 is depicted. The view 500 may be presented, for example, at the client device 108-1. In particular, the view 500 includes a portion of the navigational region 408 based on the location of the avatar 420 within the navigational region 408 and a field of view of the avatar 420. The field of view may be a predefined field of view. When the portion of the navigational region 408 located within the field of view of the avatar 420 includes child nodes 412, the view 500 may additionally depict the objects designated by the child nodes. For example, in the present example, the view 500 includes the asset representation 416. In some examples, the view 500 may additionally depict at least a portion of the avatar 420 itself. The portion of the avatar 420 depicted in the view 500 may depend on a point of view (e.g., first person point of view, third person point of view, birds eye view, etc.). In the present example, a third person point of view is depicted, and hence the avatar 420 is visible in the view 500.

The user may then use the client device 108-1 to view and navigate the model. In particular, the user may navigate the avatar within the navigational region of the model. To do so, the client device 108-1 may generate a navigation request. The navigation request includes a target location within the navigational region. For example, the target location may be specified by particular target coordinates. In other examples, the navigation request may include a direction and magnitude, and the target location may be computed based on the current location of the avatar, the direction and the magnitude.

In some examples, the client device 108-1 may send the navigation request to the server 104. In response to the navigation request, the server 104 may navigate the avatar within the navigational region to the target location. Preferably, the navigation request and navigation of the avatar to the target location happens in substantially real-time to optimize the user experience. That is, the view presented at the client device 108-1 may update in real-time to simulate navigation in first-, third- or other appropriate points of view through the model.

As will be appreciated, in some examples, rather than sending the navigational request to the server 104, the model may be loaded locally at the client device 108-1 and the client device 108-1 may navigate the avatar within the navigational region to the target location.

Returning to FIG. 3, at block 330, after presenting the model at the client device 108-1 for navigation by the user, the client device 108-1 may additionally provide for interaction requests with the model based on input from the user of the client device 108-1. The interaction request may specify a target asset representation with which to interact and an interaction. For example, the interaction may be a transformation of the asset representation (e.g., to move it to a different location, to rotate it, or the like) or a modification of the asset representation (e.g., to affix the asset representation to a wall or another component within the navigational region). In other examples, the interaction may be to simulate a process executable by the asset representation (e.g., running a utility unit or the like). The client device 108-1 may send the interaction request to the server 104 for processing, or in some examples, may process the interaction request locally.

At block 335, the server 104 manipulates the asset representation in accordance with the interaction request. For example, if the interaction request specifies a transformation of the asset representation, the server 104 may move the asset representation to the target location specified in the interaction request. That is, the server 104 may transform the asset representation in the coordinate system of the navigational region of the model in accordance to the specifications of the interaction request. Preferably, the interaction request and the manipulation of the asset representation happens in substantially real-time to optimize user experience. That is, the view presented at the client device 108-1 may update in real-time to simulate the manipulation of the asset representation in the model.

As will be appreciated, the navigation requests and interaction requests may happen simultaneously. For example, the user may navigate the avatar to within a threshold distance of an asset representation, the client device 108-1 may present an option to pick up the asset representation. The interaction request may therefore be to pick up the asset representation. In such examples, the server 104 may associate the node designating the asset representation as a child of the node designating the avatar. Subsequently, when the user navigates the avatar within the navigational region, the asset representation which is tied to the avatar as a child node of the avatar is also moved in the same manner (i.e., to the same location) as the avatar. The client device 108-1 may also present an option to drop the asset representation, at which point the node designating the asset representation may be disassociated from the node designating the avatar and return to its state as a child node of the root node designating the navigational region.

At block 340, in response to the manipulation of the asset representation, the server 104 computes a physical response of the physical asset and the workspace as a result of the interaction.

The physical response may be based on the size and/or dimension of the physical asset and the workspace when the asset representation is located at the designated location in the navigational region, based on the stresses or forces of the physical asset and the workspace based on the asset representation and/or its relationship to the other components of the navigational region. Other physical responses which may be computed will also be apparent to those of skill in the art.

To compute the physical response, for example based on the size and/or dimension of the physical asset and the workspace, the server 104 may compare the dimensions of the asset representation to nearby boundaries, such as walls or ceilings, or nearby objects, such as other child nodes designating other asset representations. If the asset representation intersects such nearby boundaries or other objects, based on its location and its size, the server 104 may generate, as the physical response, an indication that the asset representation would not fit at that location. In some examples, in addition to simply determining an intersection, the server 104 may determine whether the asset representation is within a threshold distance of nearby boundaries or other objects, based on a threshold clearance distance for the physical asset. In such examples, the physical response may be an indication of whether the threshold clearance distance is met or not.

To compute the physical response, for example based on the stresses or forces of the physical asset and the workspace, the server 104 may retrieve the properties of the physical asset and any components with which it interacts as well as a library of principles governing the responses of the components (i.e., formulae to compute the stresses, forces, or other responses exerted by or on the components). For example, these properties may be predefined and stored in the memory 204 in association with the asset representation. The properties may include weight or mass, material, strengths, such as specific strength, tensile strength, compressive strength, and other relevant properties.

Based on the properties of the asset representation, any components with which it interacts (e.g., walls, frames, beams, etc.), and the specific nature of the relationship of the components, the server 104 may use one or more formulae in the library of principles to compute the physical response.

At block 345, the client device 108-1 receives the computed physical response from the server 104 and outputs the computed physical response. For example, the client device 108-1 may present the physical response in the form of a note specifying the dimensions, stresses, forces or other responses of the asset representation and the model.

In some examples, the computed physical response may be displayed visually in the model. For example, if the size of the asset representation exceeds the size of the space in which it was moved (e.g., it intersects the walls of the utility closet or the like), the client device 108-1 may display the intersection and/or the portions of the asset representation exceeding the space in a visually distinct manner (e.g., in a different color, texture, transparency, etc.). In some examples, the physical response may indicate a good fit, and hence the output may present an affirmative sign to indicate that no adverse physical responses were computed.

Thus, advantageously users, particularly engineers, architects, and planners, may have an interactive model to visualize construction projects in 3D, rather than simply viewing 2D schematics. This may facilitate the planning and architecture process. Additionally, the system uses a hierarchical node structure to allow navigation around objects located in the navigational region. For example, a sample part may be imported from a CAD model and designated as a child node in a navigational region. Users may then use this navigable model to move around the sample part in an intuitive and easy manner.

In addition to the functionality described above, the system 100 may further facilitate multi-user capabilities. That is, more than one user may log into the system 100 and view the model at once. For example, the server 104 may receive a second connection request from the client device 108-2. The second connection request may additionally specify a workspace to model and include an authentication process to authenticate the client device 108-2.

In response to the connection request from the client device 108-2, the server 104 defines an avatar for the client device 108-2 as a further child node descending from the root node. The avatar is a figure representing the client device 108-2 (or a user of the client device 108-2) within the model. Since the avatar is designated as a child node of the root node, the server 104 locates the avatar within the navigational region designated by the root node. The avatar for the second client device 108-2 may be located, for example, at the predefined start location.

As a child node of the root node, the model, including all presented instances of the model, are updated to include the newly generated avatar representing the second client device 108-2. Thus, the server 104 presents the model with the avatar for the first client device 108-1 and the second avatar for the second client device 108-2 to the second client device 108-2. Further, the model presented at the first client device 108-1 may be updated to include the avatar for the second client device 108-2.

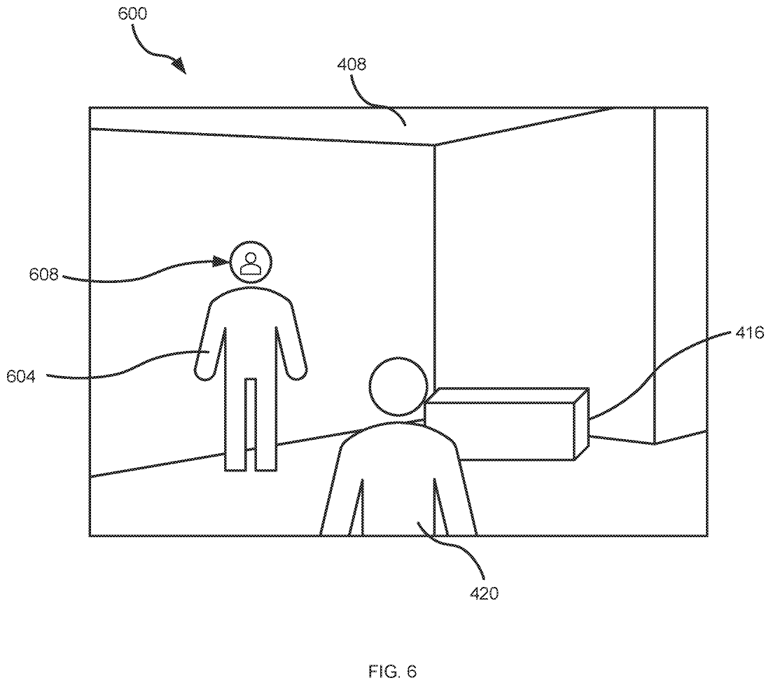

For example, referring to FIG. 6, a schematic diagram of another rendered view 600 is depicted. In particular, the view 600 may be the view presented at the client device 108-1 when a new avatar for the client device 108-2 is designated by a new child node in the node structure 400. As can be seen, the view 600 is similar to the view 500 and includes a portion of the navigational region 408 based on the location of the avatar 420 within the navigational region 408 and the field of view of the avatar 420. The view 600 further includes an avatar 604 representing the second client device 108-2.

When more than one avatar is present in the model, the system 100 may further enable video and audio exchange. In particular, the server 104 may receive the video and audio feeds from the respective client devices 108 and present them together with the model. In some examples, the video and audio feed may be associated with the avatar of the corresponding client device 108. For example, the avatar 604 has a display region 608 in which a video feed of the user of the client device 108-2 is displayed. The avatar 420 may have a similar display region visible by other users. In other examples, the video feeds may be displayed in a designated video display region (e.g., a side, top or bottom panel, or the like).

In addition to the interaction requests, the system 100 may additionally allow for other actions, such as measurements, layers, and virtual annotations. For example, to perform distance measurements, the user of a client device 108 may select two points within the navigational region and the server 104 may compute the distance between the two points.

The system 100 may also provide the capability to provide different layers of asset representations, for example to review different layout or configuration options and to quickly toggle these views on and off. In such examples, the node structure may include an intermediary node designating the layer which is a child node of the root node. The asset representations may then be child nodes of the layer node rather than the root node directly. Thus, when the server 104 receives a request to toggle the layer on or off, the server 104 may display or hide each of the asset representations or other objects which are children of the layer node. That is, when the layer node is toggled on, the server 104 displays the asset representations in the model for any asset representations which are designated by child nodes of the layer node. When the layer node is toggled off, the server 104 hides the asset representations in the model for any asset representations which are designated by child nodes of the layer node.

The virtual annotations are enabled by defining a node designating an annotation (e.g., a text-based sticky note, images, etc.). The annotation node may be a child node of the root node, and hence may be located at particular coordinates within the navigational region, or the annotation node may be a child node of an object, such as an asset representation node, and hence may be associated with the asset representation, and more specifically, particular coordinates of the asset representation. The server 104 may then save the annotation as being defined and assigned to a location within its parent node. In other words, when the target annotation location is associated with an asset representation, the annotation node may be defined as descending from the child node designating the corresponding asset representation. When the target annotation location is not associated with the asset representation, the annotation node may be defined as descending from the root node.

The annotations may be displayed with a symbol, such as a sphere, or other appropriate symbol to clearly and visibly indicate to users that an annotation exists at that location within the model. Subsequently, when an avatar approaches the location of the annotation and reaches a threshold proximity from the location, the annotation may transform from the symbol to present the annotation. For example, the server 104 may explode the symbol to a text box including the text of the annotation.

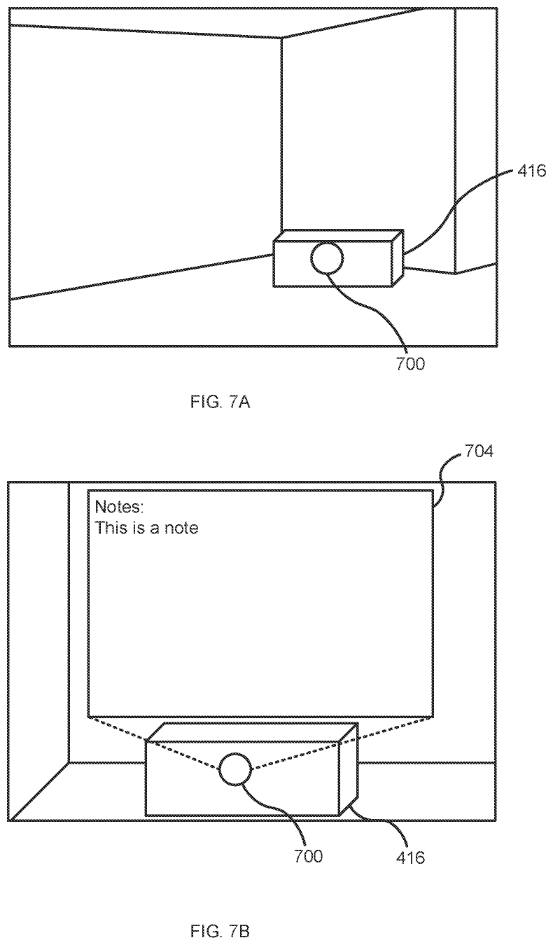

For example, FIGS. 7A and 7B depict views including an annotation represented as a symbol, and the annotation as presented when the avatar reaches a threshold proximity of the annotation. In particular, FIG. 7A depicts an annotation 700 on the asset representation 416. When the avatar moves within a threshold proximity of the annotation 700, the annotation 700 expands to present a note 704.

The server 104 may additionally run one or more artificial intelligence algorithms to perform object detection and recognition on the model. For example, the server 104 may be trained to recognize certain types of objects, as well as certain defects. Upon recognizing the objects or defects, the server 104 may provide additional output to be presented at the client devices 108. In some examples, the output may be provided when the avatar associated with the respective client device 108 reaches a threshold proximity of the recognized object or defect.

In some examples, in addition to presenting the model as a navigable model, the server 104 may include the option for a 360° view. In the 360° view, the client device 108-1 presents a view which may be rotated in 360° about a single point. The artificial intelligence systems may additionally be applied to these views to facilitate recognition and detection of the items in the current view.

In still further examples, the server 104 may support augmented reality, or other mixed or extended reality. For example, a client device 108 may capture data (e.g., image data and/or depth data) and exchange such data in real-time with the server 104. The server 104 may compare the captured data to stored models to correlate the current view from the client device 108 with a view of a model. If the server 104 can correlate the data, the server 104 may send the model data or a portion of the model data to the client device 108. For example, the server 104 may send an asset representation, including its location within the navigational region, to the client device 108. The client device 108 may then display, as an augmented reality component, the asset representations representing the proposed location of the physical asset.

In some examples, the server 104 may support package selection for the model based on the target platform. That is, the server 104 may obtain, from the client device 108, properties of the client device 108. The properties may include a type of device (e.g., mobile phone, desktop, etc.), an operating system, and other performance capabilities.

Based on the received properties, the server 104 may package the model in an appropriate form to optimize performance and output on the client device 108.

The scope of the claims should not be limited by the embodiments set forth in the above examples, but should be given the broadest interpretation consistent with the description as a whole.

1. A method comprising:
obtaining a workspace definition representing a workspace and an asset definition representing a physical asset located within the workspace;
generating a model by: (i) defining a root node for the model, the root node designating a navigational region of the model based on the workspace definition, and (ii) defining at least one child node descending from the root node, the child node designating an asset representation based on the asset definition;
in response to a connection request from a client device:
defining an avatar for the client device as a further child node descending from the root node;
locating the avatar within the model in the navigational region; and
presenting the model with the avatar to the client device;
in response to a navigation request from the client device, the navigation request specifying a target location, navigating the avatar within the navigational region to the target location;
in response to an interaction request from the client device, the interaction request specifying an interaction of the asset representation relative to the workspace, manipulating the asset representation in accordance with the interaction request;
in response to manipulating the asset representation, computing a physical response of the physical asset and the workspace as a result of the interaction; and
outputting the computed physical response.

2. The method of claim 1, the workspace definition comprises one of: a computer-aided design model of the workspace or a generated model built based on captured data representing the workspace.

3. The method of claim 1, wherein the asset definition comprises one of: a computer-aided design model of the physical asset or a generated model built based on captured data representing the physical asset.

4. The method of claim 1, further comprising, in response to a second connection request from a second client device:
defining a second avatar for the second client device as a second further child node descending from the root node;
locating the second avatar within the model in the navigational region; and
presenting the model with the avatar and the second avatar to the second client device.

5. The method of claim 4, further comprising updating the model presented to the client device to include the second avatar.

6. The method of claim 1, wherein the interaction comprises one or more of: a transformation of the asset representation, a modification of the asset representation, and a process executable by the asset representation.

7. The method of claim 1, wherein the physical response is computed based on one or more of: a size and/or dimension of the physical asset, and stresses and/or forces of the physical asset and the workspace.

8. The method of claim 1, further comprising:
receiving an annotation and a target annotation location;
when the target annotation location is associated with the asset representation, defining an annotation node descending from the child node designating the asset representation; and
when the target annotation location not associated with the asset representation, defining the annotation node descending from the root node.

9. The method of claim 8, further comprising, when the avatar navigates within a threshold proximity of the target annotation location, presenting the annotation at the client device.

10. The method of claim 1, further comprising:
defining a layer node as an intermediary node between the root node and the child node; and
when the layer node is toggled on, displaying the asset representation in the model; and
when the layer node is toggled off, hiding the asset representation in the model.

11. A server comprising:
a memory;
a processor interconnected with the memory, the processor configured to:
obtain a workspace definition representing a workspace and an asset definition representing a physical asset located within the workspace;
generate a model by: (i) defining a root node for the model, the root node designating a navigational region of the model based on the workspace definition, and (ii) defining at least one child node descending from the root node, the child node designating an asset representation based on the asset definition;
in response to a connection request from a client device:
define an avatar for the client device as a further child node descending from the root node;
locate the avatar within the model in the navigational region; and
present the model with the avatar to the client device;
in response to a navigation request from the client device, the navigation request specifying a target location, navigate the avatar within the navigational region to the target location;
in response to an interaction request from the client device, the interaction request specifying an interaction of the asset representation relative to the workspace, manipulate the asset representation in accordance with the interaction request;
in response to manipulating the asset representation, compute a physical response of the physical asset and the workspace as a result of the interaction; and
output the computed physical response.

12. The server of claim 11, the workspace definition comprises one of: a computer-aided design model of the workspace or a generated model built based on captured data representing the workspace.

13. The server of claim 11, wherein the asset definition comprises one of: a computer-aided design model of the physical asset or a generated model built based on captured data representing the physical asset.

14. The server of claim 11, wherein the processor is further configured to, in response to a second connection request from a second client device:
define a second avatar for the second client device as a second further child node descending from the root node;
locate the second avatar within the model in the navigational region; and
present the model with the avatar and the second avatar to the second client device.

15. The server of claim 14, wherein the processor is further configured to update the model presented to the client device to include the second avatar.

16. The server of claim 11, wherein the interaction comprises one or more of: a transformation of the asset representation, a modification of the asset representation, and a process executable by the asset representation.

17. The server of claim 11, wherein the physical response is computed based on one or more of: a size and/or dimension of the physical asset, and stresses and/or forces of the physical asset and the workspace.

18. The server of claim 11, wherein the processor is further configured to:
receive an annotation and a target annotation location;
when the target annotation location is associated with the asset representation, define an annotation node descending from the child node designating the asset representation; and
when the target annotation location not associated with the asset representation, define the annotation node descending from the root node.

19. The server of claim 18, wherein the processor is further configured to, when the avatar navigates within a threshold proximity of the target annotation location, present the annotation at the client device.

20. The server of claim 11, wherein the processor is further configured to:
define a layer node as an intermediary node between the root node and the child node; and
when the layer node is toggled on, display the asset representation in the model; and
when the layer node is toggled off, hide the asset representation in the model.
